(19) United States
(12) Patent Application Publication
(10) Pub. No.: US 2011/0317965 A1
(43) Pub. Date: Dec. 29, 2011

(54) OPTICAL SUBASSEMBLY WITH OPTICAL DEVICE HAVING CERAMIC PACKAGE

(75) Inventors: Yasushi Fujimura, Yokohama-shi (JP); Keiji Tanaka, Yokohama-shi (JP); Shunsuke Sato, Yokohama-shi (JP); Masaki Migita, Yokohama-shi (JP)

(73) Assignee: SUMITOMO ELECTRIC INDUSTRIES, LTD., Osaka-shi (JP)

(21) Appl. No.: 13/255,718

(22) PCT Filed: May 12, 2010
(86) PCT No.: PCT/JP2010/058398

§ 371 Date: Sep. 9, 2011

(30) Foreign Application Priority Data
May 12, 2009 (JP) 2009-115633
Nov. 4, 2009 (JP) 2009-252932
Nov. 4, 2009 (JP) 2009-252954
Nov. 4, 2009 (JP) 2009-252969

(51) Int. Cl. G02B 6/36

(52) U.S. Cl. 385/93; 385/94

(57) ABSTRACT

An optical subassembly (OSA) with a newly arranged optical device is disclosed. The OSA provides a ceramic package that installs a semiconductor optical device, a joint portion welded to a lid of the ceramic package, and an optical coupling portion that receives an external optical fiber. In the OSA, the seal ring put between the top of the multi-layered ceramic package and the lid is isolated from the optical device; accordingly, the lid, the joint portion and the optical coupling portion are electrically isolated from the semiconductor optical device even when the OSA is installed in an optical apparatus such as an optical transceiver.

### TECHNICAL FIELD

The present invention relates to an optical subassembly optically coupled with an external optical fiber, in particular, the invention relates to an optical subassembly that provides a multi-layered ceramic package to install a semiconductor optical device therein.

### BACKGROUND ART

The U.S. Pat. No. 7,476,040 discloses one type of optical subassembly (hereafter denoted as OSA) that comprises a ceramic package to install semiconductor devices therein and a flexible printed circuit (FPC) board attached to the bottom of the ceramic package with the ball grid arrays (BGA) to connect the subassembly electrically with the circuit board.

The ceramic package disclosed therein has a transitional cap made of metal and an optical coupler to receive an external fiber that is to be coupled with an optical transducer in the ceramic package. The optical coupler is assembled with a cylindrical portion of the cap by an adhesive, which electrically isolates the optical coupler from the metal cap. The metal cap is attached to the sealing ring, and this sealing ring is electrically guided to the bottom of the package with via holes. Thus, the cap of the disclosed OSA is electrically connected with the circuit ground through via holes and the FPC board. Only the adhesive inserted between the optical coupler and the transitional cap may show a function of an electronic insulator.

Moreover, the optical transducer and other electronic components are mounted on the top surface of the multi-layered ceramic package, where wiring patterns are formed. The OSA disclosed therein installs the optical transducer and other electronic components in the “flip chip” arrangement directly on the wiring patterns to decrease parasitic components of the electronic connection. Only the direct wiring from the optical transducer to the trans-impedance amplifier (TIA) arranged adjacent to the optical transducer is to reduce the parasitic component attributed to the wiring.

### SUMMARY OF INVENTION

An aspect of the present invention is an OSA used in an optical equipment such as optical transceiver. The OSA of the invention has a feature that the OSA comprises an optical device, a coupling portion, and a joint portion. The optical device that installs a semiconductor optical device as an optical transducer includes a plurality of ceramic layers, a metal lid, and a seal ring between a top surface of ceramic layers and the metal lid; the coupling portion receives an external fiber that optically couples with the semiconductor optical device; and the joint portion assembles the optical device with the coupling portion. In the OSA of the invention, the joint portion is welded to the metal lid of the optical device.

The ceramic package of the optical device may include at least three ceramic layers; namely, the lower ceramic layer, the intermediate ceramic layer and the upper ceramic layer. The semiconductor optical device may be mounted on a top surface of the lower ceramic layer which is exposed in an opening formed in the intermediate layer. The top surface of the intermediate ceramic layer may provide electrically conductive patterns thereof which are connected with electrically conductive patterns provided in a bottom surface of the lower ceramic layer with a plurality of via holes.

In one embodiment, the intermediate ceramic layer may have a thickness substantially equal to a thickness of the semiconductor optical device; thus, a horizontal level of the top surface of the intermediate ceramic layer becomes equal to a horizontal level of a top surface of the semiconductor optical device, which may shorten a length of a bonding wire electrically connecting the semiconductor optical device with the conductive pattern on the intermediate ceramic layer.

In one embodiment, the optical coupling portion may be made of metal, and the joint portion may also be made of metal; accordingly, the optical coupling portion may be electrically connected to the seal ring through the joint portion and the metal rid. However, the optical coupling portion may be electrically isolated from the electrically conductive patterns formed on the top surface of the intermediate ceramic layer. When the OSA is installed within the optical transceiver with an electrically conductive housing, and the optical device is coupled with a circuit in the optical transceiver with an FPC board extracted from the bottom of the lower ceramic layer, the coupling portion and the joint portion may be electrically isolated from the signal ground for the circuit of the optical transceiver but grounded to the frame ground provided in the conductive housing of the transceiver, which may enhance the EMI (electro-magnetic interference) tolerance of the optical transceiver.

In one embodiment, the OSA may have a laser diode (LD) as the semiconductor optical device whose optical axis is substantially in parallel to a primary surface of the ceramic package. The optical device may further provide an optical element and a monitor photodiode (PD). The optical element reflects a portion of light emitted from the LD toward a direction in substantially in perpendicular to the primary surface of the ceramic package, while, the optical element refracts another portion of the light toward the monitor PD. In the OSA, the LD, and optical element, and the monitor PD may be mounted on the top surface of the lower ceramic layer exposed in the opening of the intermediate layer.

In the arrangement for the LD, the LD may be mounted on a top surface of a sub-mount, and the sub-mount may be mounted on the top surface of the lower ceramic layer. The top surface of the sub-mount may have a horizontal level substantially equal to the top surface of the intermediate ceramic layer. Thus, the arrangement may shorten a length of the bonding wire connecting the electrically conductive pattern on the intermediate ceramic layer with an electrically conductive patter on the top surface of the sub-mount.

In one embodiment, the OSA may provide a prism as the optical element. The prism may have a light-incident surface facing the LD and a light-emitting surface facing the monitor PD. Moreover, the light-incident surface of the prism may make an angle of substantially 45° with respect to the primary surface of the ceramic package. Additionally, the prism may have another surface facing the sub-mount that mounts the LD. The other surface of the prism may have a chamfered corner in a lower side thereof, which provides a recess into which an excess solder to mount the sub-mount may be escaped.

In another embodiment, the OSA may have a PD as the semiconductor optical device. The lid may secure a lens in a center thereof. The PD may receive light provided from the external fiber and concentrated by the lens.

In still another embodiment, the OSA may have a VCSEL (Vertical Cavity Surface Emitting Laser diode) as the semiconductor optical device and a monitor PD that monitors light emitted from the back surface of the VCSEL. The monitor PD may be mounted on the top surface of the lower ceramic layer as those appeared in previous embodiments. The VCSEL in the present type of the OSA may be mounted on the top surface of the intermediate layer. In a modified arrangement of this type of the OSA, the upper ceramic layer may include a first upper layer and a second upper layer on the first upper layer. The first upper layer may provide an opening greater than the opening provided in the beneath layer and aligned therewith. The VCSEL may be mounted on the top of the intermediate layer, while the monitor PD may be mounted on the top surface of the lower layer just beneath the VCSEL. The optical arrangement of this type of the OSA may enhance the optical coupling efficiency between the VCSEL and the monitor PD.

The ceramic package may have a substantially rectangular shape. The lower ceramic layer may provide a half via in at least one of edges of the rectangular shape thereof. Because the half via is externally opened even after the FPC board is soldered to the half via, the wettability of the solder may visually investigated.

The lower ceramic layer may have a width smaller than that of the intermediate layer, where the intermediate layer in an edge thereof makes an overhang to the lower layer. When the FPC board is outwardly extended from the edge where the intermediate layer forms the overhang, the FPC board may be bent at immediately close to the edge of the intermediate layer. The electrically conductive pattern on the FPC board that carries a high speed electrical signal may be connected to the half via provided in the edge the FPC board is extended therefrom. In this arrangement, the high speed signal is transmitted on the shortest conductive pattern of the FPC board; the signal degradation may be suppressed. On the other hand, the conductive pattern on the FPC board that carries a low speed or DC electrical signal including only low frequency or DC components may be connected to a half via provided in one of edges of the lower ceramic layer and continued to a half via provided in the edge of the intermediate layer, where the half via in the lower ceramic layer and the half via in the intermediate layer is aligned.

The ceramic package of the present OSA may have a thickness of 2 mm at most. A thicker ceramic package may increase a cost thereof. The seal ring may have an aspect ratio smaller than 1.5 in the cross section thereof, which may be processed by pressing Kovar to reduce the cost thereof. The lid may be made of alloy of iron (Fe) and nickel (Ni), while, the joint portion may be made of stainless steel. The linear thermal expansion co-efficient becomes larger in this order, which may enhance the productivity, in particular, the seam sealing of the lid with the seal ling, and the YAG laser welding of the joint portion with the rid.

### BRIEF DESCRIPTION OF DRAWINGS

The foregoing and other purposes, aspects and advantages will be better understood from the following detailed description of a preferred embodiment of the invention with reference to the drawings, in which:

FIG. 1 is a perspective view of the OSA according to the first embodiment of the invention;

FIG. 2 shows a cross section of the OSA shown in FIG. 1;

FIG. 3 magnifies a primary portion of the OSA shown in FIG. 1;

FIG. 4 is a perspective view of an OSA according to the second embodiment of the invention, where a portion of the OSA is broken to show an inside of the OSA;

FIG. 5 magnifies an inside of the optical device shown in FIG. 4;

FIG. 6 further magnifies the inside of the optical device, where the multi-layered ceramic package provided in the optical device is cut to show the stacking arrangement thereof;

FIG. 7 shows an optical coupling arrangement of the optical device shown in FIGS. 4 to 6;

FIG. 8 shows an inside of another type of an optical device according to the third embodiment of the invention;

FIG. 9 is a cross section of the multi-layered ceramic package provided in the optical device shown in FIG. 8;

FIG. 10 is a cross section of an OSA according to the third embodiment of the invention;

FIG. 11 is a cross section of an optical transceiver that implements with an OSA shown in FIG. 11, 4 or 8;

FIG. 12 is a bottom view of still another type of an OSA according to the fourth embodiment of the invention;

FIG. 13 magnifies a featured portion of the OSA of the fourth embodiment shown in FIG. 12; and

FIG. 14 is a bottom view of an OSA according to the fifth embodiment of the invention, which is modified from the OSA shown in FIG. 12.

### DESCRIPTION OF EMBODIMENTS

Next, preferred embodiments according to the present invention will be described as referring to accompanying drawings.

### First Embodiment

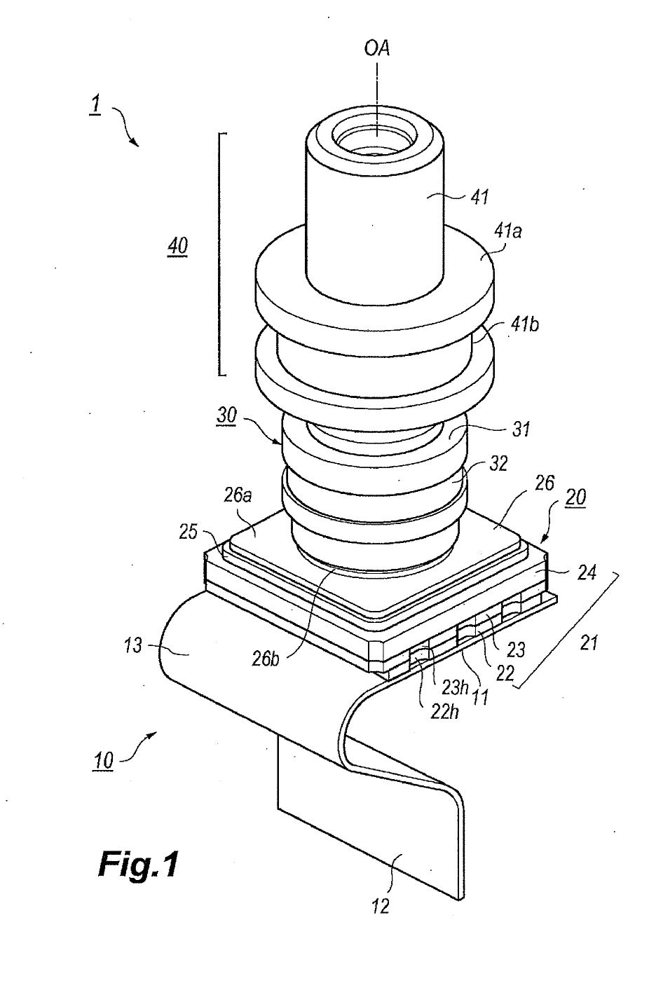

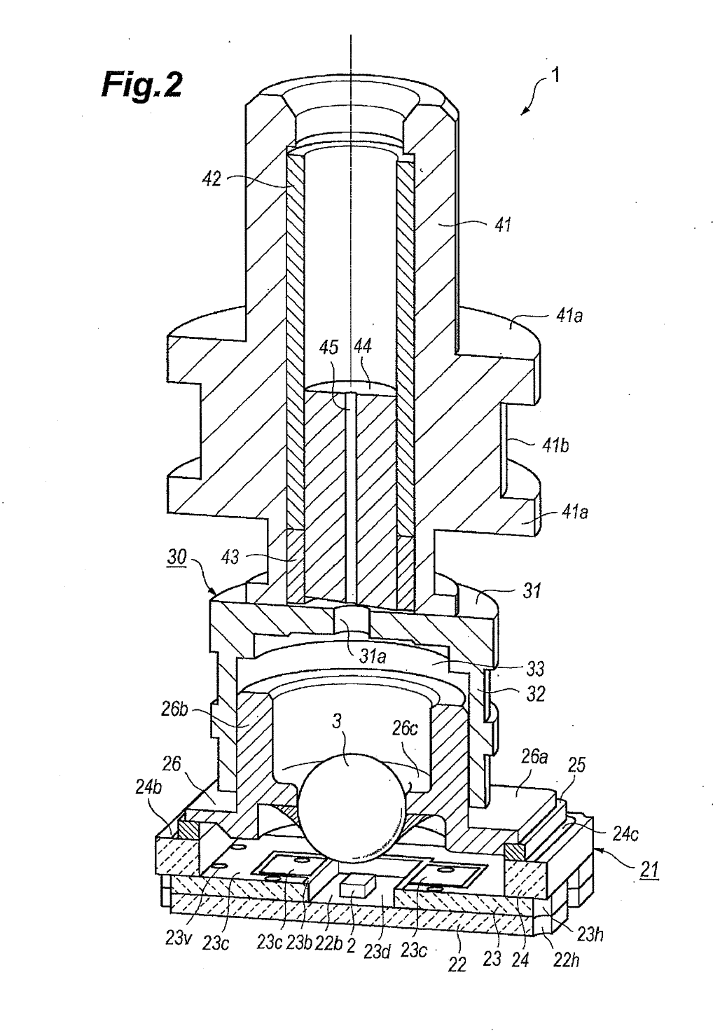

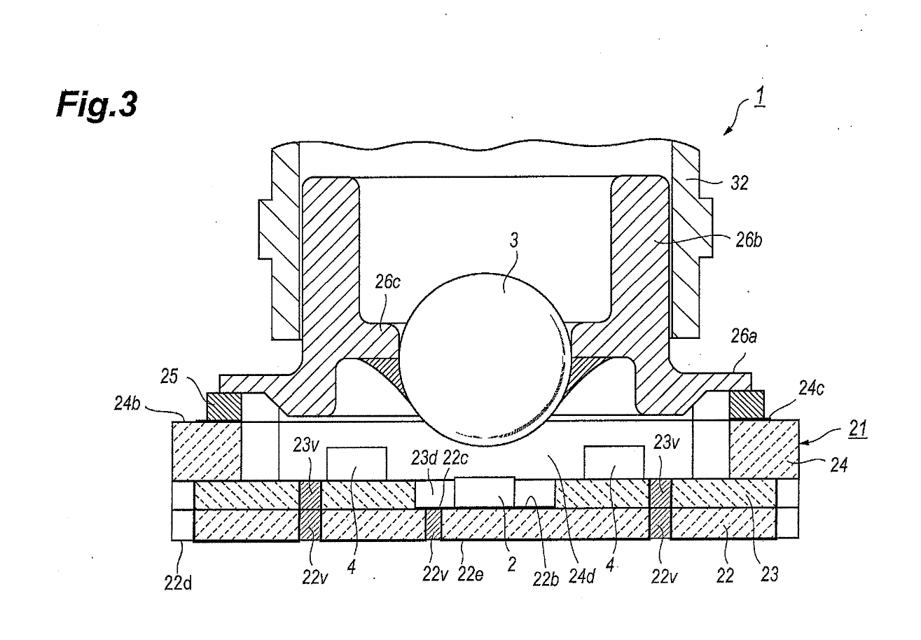

FIG. 1 is a perspective view of an OSA 1 according to the first embodiment of the invention; FIG. 2 is a cross section of the OSA 1; and FIG. 3 magnifies a primary portion of the OSA 1. The OSA 1 may be a transmitter OSA (TOSA) including a light emitting device, typically a semiconductor laser diode (hereafter simply denoted as LD), or a receiver OSA (ROSA) including a semiconductor light-receiving device, typically a photodiode (hereafter simply denoted as PD). The OSA 1 according to the present embodiment comprises a coupling portion 40, a joint portion 30, an optical device 20 and a flexible printed circuit (hereafter simply denoted as FPC) board 10.

The optical device 20 includes a multi-layered ceramic package 21 that comprises a tri-layer of a lower ceramic layer 22, an intermediate ceramic layer 23, and an upper ceramic layer 24. The intermediate layer 23 is provided on the lower layer 22, while the upper layer 24 is provided on the intermediate layer 23. These ceramic layers may be made of alumina (Al₂O₃) typically applied in a conventional ceramic package and formed by sintering. The ceramic package 21 has a rectangular outer shape.

The lower layer 22 provides metallized patterns 22c on the top surface 22b thereof, and another metallized patterns 22e on the bottom surface 22d thereof. The lower layer 22 provides a plurality of via holes 22v electrically connecting the metallized patterns 22c on the top surface 22b with the other metallized patterns 22e on the bottom surface 22d. The via holes 22v are filled with metal.

The intermediate ceramic layer 23 provides on the top surface 23b thereof metallized patterns 23c. The intermediate ceramic layer 23 also has a plurality of via holes 23v electrically connecting the metallized pattern 23c with the metallized pattern 22c on the top of the lower ceramic layer 22. Formed in a center portion of the intermediate ceramic layer 23 is an opening 23d which constitutes a cavity where an optical element 2 is mounted on the top 22b of the lower layer 22; specifically, the optical element 2 is mounted on the top surface 22b of the lower layer 22 exposed within the opening 23d. The optical element may be an LD or a PD. The intermediate layer 23 has a thickness similar to that of the lower layer 22 in the present embodiment.

The upper layer 24 forms a space 24d in which a plurality of electronic device 4 is installed. The upper ceramic layer plays a role of side walls of the ceramic package 21. The top surface 23b of the intermediate layer 23 mounts electronic devices 4 such as IC, resistor, capacitor, something like those, and forms electrically conductive patterns 23c electrically connecting these devices 4 with respective bonding wires. A thickness of the upper layer 24 is set to be relatively thicker compared with that of the intermediate layer 23 to form a substantial space for the wiring. In the present embodiment, a total thickness of the ceramic layers, 22 to 24, may be less than 2 mm to reduce the cost thereof.

The top surface 24b of the upper layer 24 forms another conductive patter 24c; but, in contrast to the arrangements of the intermediate and lower layers, 22 and 23, the conductive pattern 24c does not provide any via holes electrically connected thereto. This conductive pattern 24c is connected with a seal ring 25 by, for example, brazing. The seal ring 25 mounts a lid 26 that hermetically seals the openings, 22d and 23d. A lens 3 is secured on a center of the lid 26 by, for instance, sealing glass. The seal ring 25 may be made of an alloy of nickel (Ni) and iron (Fe), and have an aspect ratio smaller than 1.5 in the cross section thereof. Such a small aspect ratio may realize that the seal ring is formed by pressing, which drastically reduces the cost thereof.

The lid 26 has a ceiling portion 26a, which is coupled with the seal ring 25 and seals the opening of the space 24d, and a guide portion 26b which is integrally formed with the ceiling portion 26a and has a cylindrical shape. The axis of the cylindrical guide portion 26 is substantially perpendicular to the primary surface of the ceramic package 21, namely, the top surface 22b of the lower layer 22 and the top surface 23b of the intermediate layer 23. The lens 3 is secured in a center of the extension wall 26c extending in a bore of the guide portion 26b. Fixing the lid 26 to the seal ring 25, the lid 26 is adjusted on the seal ring 25 so as to align the optical axis of the lens 3 with the axis of the device 2 mounted on the top surface 22b of the lower layer 22. Although the embodiment shown in FIGS. 1 and 2 provides the lid integrally providing the ceiling portion 26a and the guide portion 26b, the guide portion 26b may be formed independently on the ceiling portion 26a. The lid may be made of Kovar, which is also an alloy of nickel (Ni) and iron (Fe), and is fixed with the joint portion 30 with for instance, the YAG laser welding. When the YAG laser welding is applied, the cylinder 32 described below is preferably thinner to co-alloy the surface of the guide portion 26b; while the guide portion 26b is relatively thicker to prevent the pin hole reaching the bore.

The joint portion 30 has a base 31 with an aperture 31a to pass the light therethrough and a cylinder 32 integrally formed with the base 31. The cylinder 32 secures in the bore thereof the guide portion 26b of the lid 26. Aligning an overlapped length between the guide portion 26b of the lid 26 and the cylinder 32, the optical alignment along the optical axis OA, namely z-axis, of the device 2 with respect to an external fiber may be carried out. After the z-axis alignment, the welding that irradiates the YAG-laser light from the outside of the cylinder 32 may cause local melting of the base 32 and the guide portion 26b to fix both members to each other. A thickness of the cylinder 36 may be thin such that the YAG-laser irradiation may melt not only the cylinder but the surface of the guide portion 26b, while too thinner cylinder may cause the misalignment due to the lack of stiffness. The cylinder 32 of the present embodiment shown in FIGS. 1 and 2 has a thickness of about 0.5 mm. Moreover, because the joint portion 30 and the lid 26 are both made of metal, the electronic contact may be also performed by the welding. The base 31 in the front flat surface thereof mounts the coupling portion 40.

The optical coupling portion 40 has a sleeve 42, a wedge member 43, a stub 44, a coupling fiber 45 and a cover 41 to cover those members. The sleeve may be, for instance, a split sleeve made of zirconia ceramics, or a rigid sleeve without any slit along the axis thereof. The stub 44 is arranged within the sleeve 42 in a side close to the joint portion 30. The stub may be a column shape securing with the coupling fiber 45 in a center thereof. The wedge member 43, which is arranged in the closest portion in the sleeve 42 continuous with the sleeve 42, is press-fitted between the stub 44 and the cover 41. The end surface of the stub 44 opposite to the one facing the joint portion 30 is processed in convex accompanied with the tip end of the coupling fiber 45. An external ferrule, which secures an external fiber in a center thereof, is also processed in convex and those two convex surfaces of the stub 44 and the external ferrule may realize the optical coupling by the physical contact (PC) without any medium having specific refractive index different from that of the optical fiber.

The cover 41 provides in the outer surface thereof a pair of flanges 41a and a necked portion 41b between the flange portions 41a. The coupling portion 40 may be aligned with the joint portion 30 for a plane perpendicular with the axis OA by sliding the portion 40 on the outer surface of the base 31 thereof; while the alignment along the axis OA, as previously explained, may be carried out by adjusting the overlapped amount between the guide portion 26b and the cylinder 32. Thus, the OSA 1 provides the ceramic package 21 where the inner openings, 22d and 23d, which arranges the devices therein may be air-tightly sealed by the lid 26 and the lens 3 in an inert gas like nitrogen.

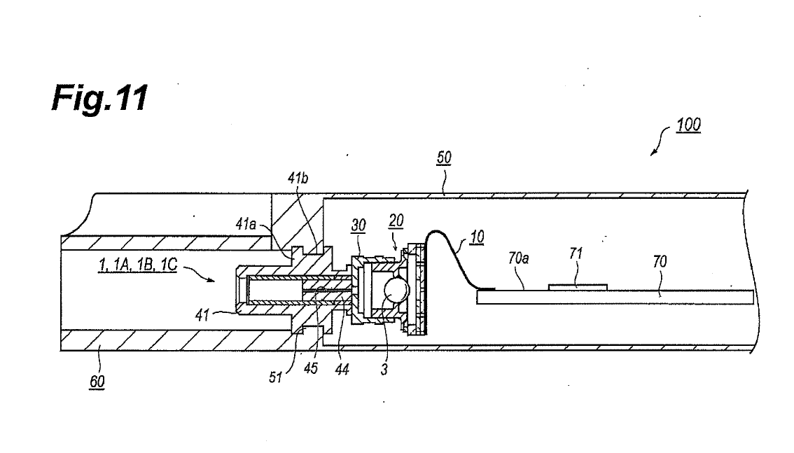

The FPC board 10 has an end 11 connected with the optical device, another end 12 connected with a circuit board and a flexible portion 13 between two ends, 11 and 12. Referring to FIG. 11, the OSA 1 according to the present embodiment may be installed in, for instance, an optical transceiver 100. The optical axis OA of the OSA 1 extends in perpendicular with the primary surface of the ceramic package 20, while the FPC board 10 extends along the primary surface of the ceramic package 20. As illustrated in FIG. 11, which is a typical cross section of the optical transceiver 100, the optical transceiver 100 has the optical axis thereof in longitudinal direction of the housing 50, where the optical transceiver 100, specifically an optical device implemented within the transceiver 100, may be optically coupled with an external optical connector inserted into an optical receptacle 60 arranged in the front end of the housing 50. In the meantime, the cross section perpendicular to the longitudinal axis of the transceiver 100 is so restricted that a space to which the FPC 10 extends is also limited. Accordingly, an electrically conducting means to couple the OSA 1 with the circuit board 70 may be effective where the conducting means has flexibility such as the FPC 10 of the present embodiment.

Further referring to FIG. 11, the optical transceiver 100 has the housing 50 with the optical receptacle in the front end thereof which receives the external optical connector securing the optical fiber. Provided in the rear end of the optical receptacle 60 is the projection 51 that mates with the necked portion 41b or mounts it thereon to position the OSA 1 within the housing 50. The optical receptacle 60 may be made of metal, or made of resin coated with metal to ensure the electronic shield. The optical transceiver 100 arranges the circuit board 70 whose primary surface 70a is in perpendicular to the primary surface of the ceramic package 20 of the optical assembly 1. One end 11 of the FPC board is attached to the bottom of the package 20, while the other end 12 thereof is connected with the end of the circuit board 70 by bending the intermediate portion 13 of the FPC 10.

The housing 50 of the optical transceiver 100 is grounded to the ground of the host system in which the transceiver 100 is installed. Thus, the OSA 1 held on the projection 51 of the housing 50 is also grounded to the host ground in the coupling portion 40, the joint portion 30, the lid 26, the seal ring 25 and the conductive pattern 24c on the top of the upper layer 24. However, because the upper conductive pattern 24c has no via holes electrically connected thereto, the intermediate layer 23 and the lower ceramic layer 22 including the conductive patterns, 22c and 23c, may be electrically isolated from the host ground. Even when the intermediate layer 23 and the lower layer 22 provide another ground layer, this other ground may be isolated from the host ground or from the housing 50 of the optical transceiver 100. The conductive patterns, 23c and 22c, on the intermediate layer 23 and the lower layer 22, respectively, are connected with the circuit board 70. Thus, the ground on the intermediate layer 23 and that of the lower layer 22 may be grounded to the ground on the circuit board 70.

In a case of a TOSA, the light-emitting device in the OSA is necessary to be provided with a large switching current to emit signal light, which becomes two noise sources; one of which is that the switching of large current induces the magnetic field and this magnetic field causes a noise current around the source; the other of which is that a large current flowing in the ground causes a fluctuation in the ground potential, which increases the common mode noise. However, because the OSA 1 according to the present embodiment electrically isolates the ground in the transceiver 100 from the host ground, the noise caused within the transceiver 100 may be restricted to lead outwardly. Further, the coupling portion 40 is electrically isolated from the electronic circuit in the housing 10, the transceiver 100 may reduce an EMI radiation; in particular, noise radiated from the tip of the coupling portion may be restricted.

The host system usually causes many noises, typically, digital noises generated by digital equipments implemented in the host system. The OSA 1 according to the present embodiment may isolate the inner ground within the housing 50 from the host ground; the transceiver 100 may be escaped from such digital noises.

### Second Embodiment

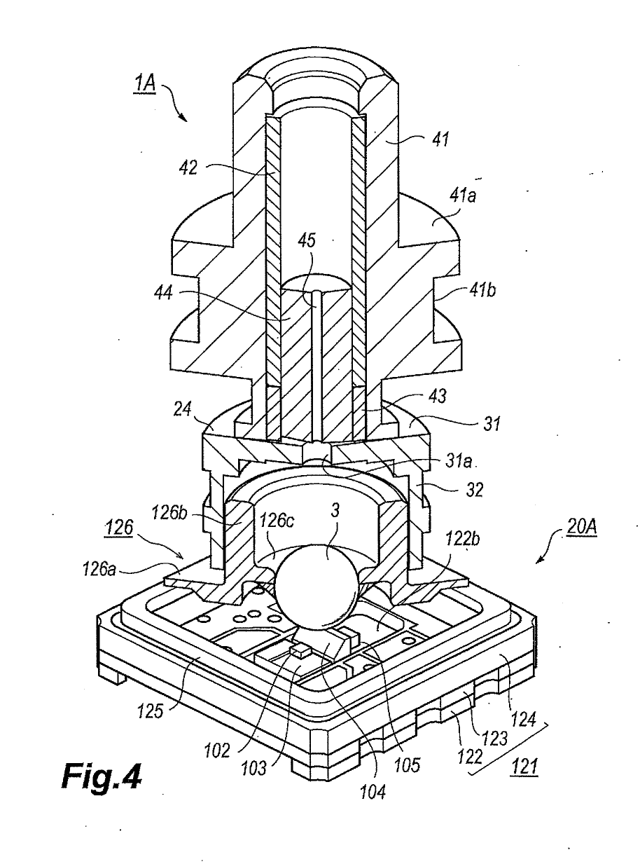

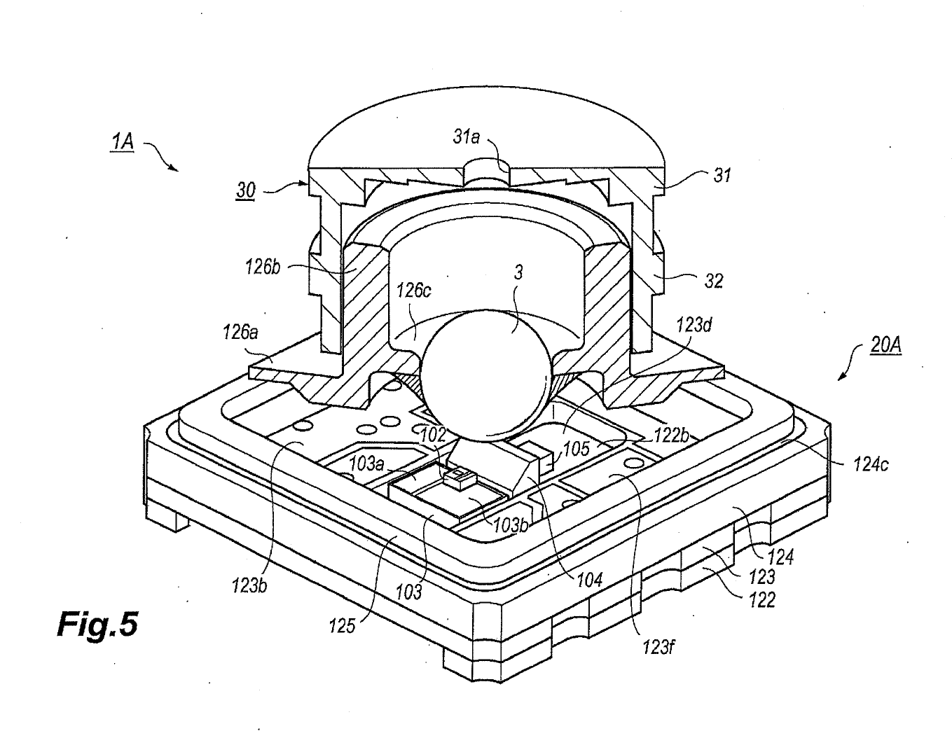

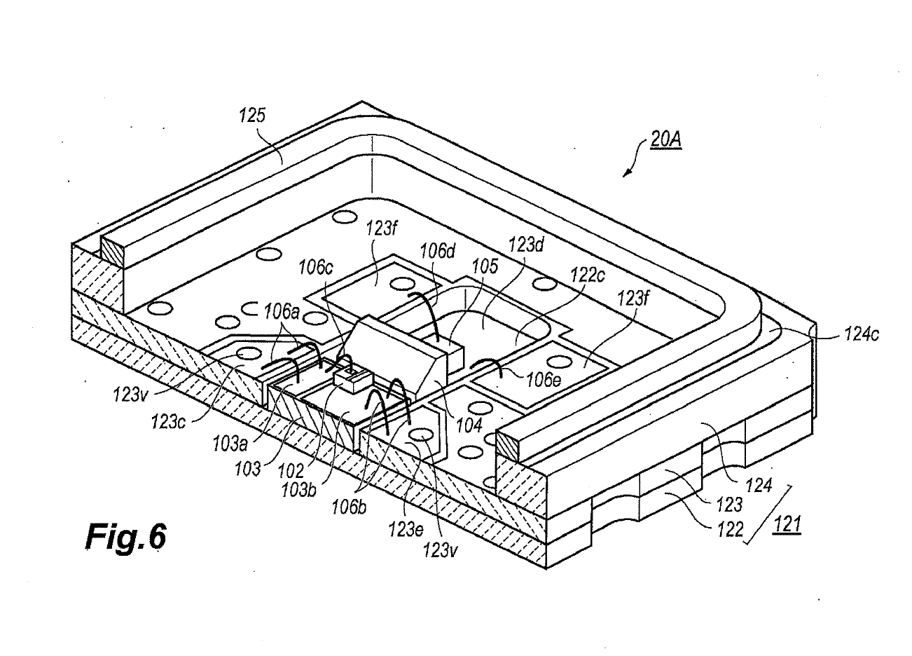

FIG. 4 is a perspective view of an OSA 1A according to the second embodiment of the invention, FIGS. 5 and 6 magnify a primary portion of the OSA 1A, and FIG. 6 shows an optical coupling arrangement in the OSA 1A. The OSA 1A has an optical device 20A instead of the optical device 20 provided in the aforementioned OSA 1. Other arrangements of the OSA 1A are same with or similar to those appeared in the OSA 1.

The optical device 20A of the present embodiment has a multi-layered ceramic package 121 that comprises of, similar to the aforementioned ceramic package 21, a lower ceramic layer 122, an intermediate ceramic layer 123, and an upper ceramic layer 123. The inter mediate layer 123 forms an aperture or an opening 123d that exposes the top surface 122b of the lower layer 122. The optical device 20A of the present embodiment mounts a semiconductor light-emitting device 102, typically an LD, in the opening 123d through a sub-mount 103, which is different from the arrangement of the optical device 20. The LD 102 is a type of the side-emitting LD and is mounted on a conductive pattern 103b on the sub-mount 103 so as to face and to make one of the electrodes of the LD 102 in contact with the conductive pattern 103b. Thus, the optical axis of the LD 102 is substantially in parallel with the primary surface 122b of the lower ceramic layer 122.

A thickness of the sub-mount 103 is comparable with that of the intermediate ceramic layer 123, thus, the upper surface of the sub-mount 103 in the horizontal level thereof is substantially identical with the upper surface 123b of the intermediate ceramic layer 123. The sub-mount 103 may be preferably made of material having the thermal conductivity greater than that of alumina (Al₂O₃) which is a primary material constituting the ceramic package 120. Aluminum nitride (AlN) is one of materials preferably used in the sub-mount 103, or, beryllium oxide (BeO), silicon carbide (SiC), Sapphire, and diamond may be also preferably used for the sub-mount 103. Heat generated in the LD 102 may be effectively conducted to the lower ceramic layer 122, which suppresses the rising of a temperature of the LD 102 to reduce the degradation of the emission from the LD 102.

A plurality of bonding wires 106a connects the conductive pattern 103a on the sub-mount 103 with the conductive pattern 123c on the top surface 123b of the intermediate layer 123. This conductive pattern 123c provides a signal to modulate the LD 102 with high frequencies. Because the horizontal level of the top of the sub-mount 103 is substantially identical with the top 123b of the intermediate layer 123; the length of bonding wires 106a may be shortened. Moreover, the conductive patter 103a on the sub-mount 103 is wire-bonded with the top electrode of the LD 102 with a bonding-wire 106c. On the other hand, the bottom electrode of the LD 102 is directly contact with the other conductive pattern 103b on the sub-mount 103, that is, the LD 102 is mounted on the conductive pattern 103b; and then, a plurality of bonding-wires 106b connects this conductive pattern 103b with the other conductive pattern 123e on the intermediate layer 123. Further, respective conductive patterns, 123c and 123e, are connected to the pads provided in the bottom surface of the lower ceramic layer 122 with via hole 123v.

Conductive patterns in the ceramic package 121 to transmit the signal with high frequencies are necessary to have specific and invariable impedance to suppress the degradation of the signal quality. Inductance component inherently attributed to the conductive pattern for the signal line 123c or the via hole 123v and capacitance component inherently caused by the coupling between the conductive patter for the signal line 123c and the ground determine the impedance of the signal line.

A monitor PD 105 is mounted in a position opposite to the LD 102 within the space 132d to monitor a portion of the light emitted from the LD 102. The monitor PD 105 accompanies with two conductive patterns 123f in both side thereof on the top 123b of the intermediate layer 132. One of the patterns 123f is connected with the top electrode of PD 105 with wires 106d, while the other pattern 132 is connected with the conductive pattern 122c on the top 122b of the lower layer 122 by the wire 106e. The conductive patter 122c may provide the ground for the PD 105.

Positioned between the sub-mount 103 and the PD 105 is an optical element 104 whose function is to bend the optical axis of the LD 102. The optical element may be a light-reflecting mirror or an optical prism. The optical element includes a light-incident surface 104a that reflects a major portion of light emitted from the LD 102 upwardly and a light-emitting surface 104b to emit a minor portion of light toward the monitor PD 105. The light-incident surface 104a makes an angle of 45° with respect to the top surface 122b of the lower layer 122 and shows a preset reflectivity for the light emitted form the LD 102. When the optical element 104 is the prism, the side facing the sub-mount 103 may abut against the sub-mount 103 to align the position of the prism 104. Moreover, this abutting surface has a chamfered corner 103c in the lowest end thereof to secure a space where an excess solder to mount the sub-mount 103 on the top 122b of the lower ceramic layer may be accumulated therein.

The optical element 104 does not restrict the shape thereof. A right-angled triangle, a pentagon, or a planer mirror may be applicable as far as the optical element provides the light-incident surface 104a and the light-emitting surface 104b. The optical element 104 may be made of glass or material with high transmittance for the wavelength of the light emitter from the LD 102. The light-incident surface may provide an optically multi-layered structure of dielectric materials whose reflectivity may be controlled by selecting the material itself and the thicknesses thereof.

Mounted on the top 123b of the intermediate ceramic layer 123 is a plurality of electronic components, although they are not illustrated in figures. The conductive patterns 123c and those electronic components are electrical coupled with bonding wires or the flip-chip bonding. The LD 102, the monitor PD 105 and those electronic components are mounted on the top surface 122b of the lower layer 122, or the top surface 123b of the intermediate layer 123, by soldering or by electrically conductive resin. Eutectic alloys of, for instance, gold-tin (AuSn) and tin-silver-copper (SnAgCu) may be used for the soldering of the components.

Referring to FIG. 5 again, the lid 126 includes the ceiling 126a fixed to the seal ring 125 to seal the space opened upwardly and the guide portion 126b integrally formed with the ceiling 126a, but two portions, 125a and 125b, may be made independently. In the latter arrangement, the ceiling 126a may provide a seal window made of planar glass that passes the light emitted from the LD 102 and seals the openings, 123d and 124d, for mounting devices. The guide portion 126b may be fixed to the ceiling 126a by YAG laser welding or adhesive.

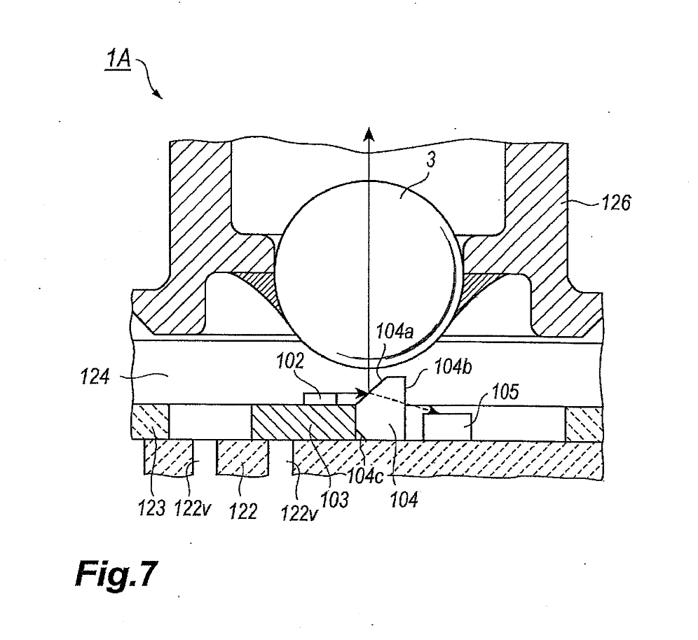

The next will describe the optical coupling between the LD 102 and the external fiber. As illustrated in FIG. 7, the light emitted from the LD 102 advances substantially in parallel to the primary surface of the ceramic package and enters the light-incident surface 104a of the optical element 104. The light thus entering the optical element 104 is reflected thereat toward, the normal of the primary surface, referred as a solid line in FIG. 7, and concentrated by the lens 3 held by the lid 126 to couple the external fiber. In the arrangement shown in FIG. 7, a portion of the light emitted from the LD 102 is refracted by the optical element, transmits therethrough and enters the monitor PD 105.

When the OSA implements with an LD of an edge-emitting type, the monitor PD is often arranged in back side of the LD to sense light emitted from the back facet of the LD. The signal lines to transmit electrical signals to drive the LD are also formed in the back side of LD. It would be preferable to shorten the signal lines that carry the electrical signal to drive the LD in high frequency regions. Because the monitor PD is necessary to be also arranged in the back side of the LD as described above, the position of the monitor PD often interferes with arrangement of the signal lines.

A wiring board with multi-layered ceramic board like the present invention may avoid the physical interference between the signal lines and the monitor PD, but, the quality of the monitored signal output from the monitor PD is often degraded by high frequency signals transmitted on the signal line because two lines are necessary to be arranged in close enough. When the monitored signal superposes the noise, in particular, high frequency noises thereon, the optical output power of the LD may be hard to be kept stable.

The OSA 1A according to the present embodiment extracts a major portion of the light emitted from the front facet of the LD 102 by reflecting with the optical element 104, and a rest minor portion of the front light of the LD 102 is detected by the monitor PD by passing the optical element 104. That is, the monitor PD 102 detects the light emitted from the front facet of the LD 102, which may avoid not only the physical interference but the degradation in the monitored signal. Moreover, the optical arrangement according to the present invention may solve a subject well known in the arrangement of the back facet monitor that a relative ratio of the front facet light to the back facet light varies as temperatures and a bias current supplied to the LD 102, which is often called as the tracking error.

The present invention is not restricted to those embodiments disclosed herein. For instance, the thickness of the sub-mount 103 may be adjusted such that the top level of the LD 102 is substantially aligned with the top surface 123b of the intermediate ceramic layer 123. That is, the thickness of the sub-mount 103 may be so adjusted that the length of the bonding wire connected to the conductive pattern on the ceramic layer becomes shortest in an average thereof, or in a sum thereof. Moreover, the embodiments illustrated in figures have the ceramic package, 21 or 121; the number of layers may be four or more.

### Third Embodiment

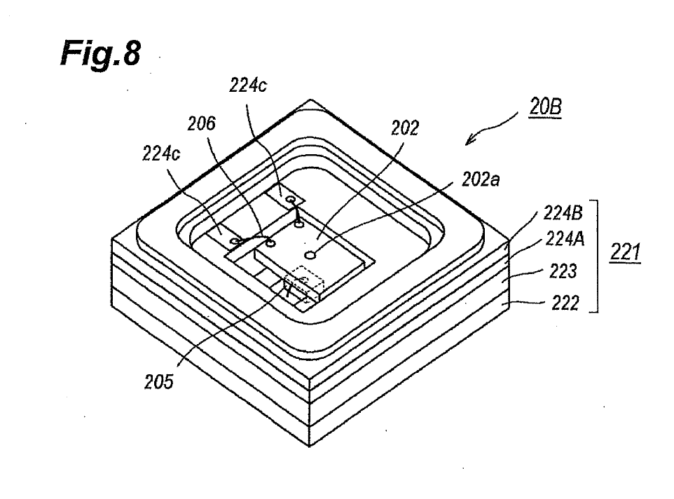

FIG. 8 is a perspective view that shows an inside of optical device 20B according to the third embodiment of the invention. The optical device 20B provides another multi-layered ceramic package 221 that installs an LD with the type of VCSEL (Vertical Cavity Surface Emitting Laser diode) and a monitor PD 205. The optical device 20B has different from aforementioned devices, 20 and 20A, in points where the present optical device 20B installs the VCSEL as a semiconductor optical device and the upper ceramic layer 224 in the multi-layered ceramic package 221 provides a double layer comprised of the first upper ceramic layer 224A and the second upper ceramic layer 224B. The monitor PD 205 is mounted on the top surface 222b of the lower ceramic layer 222, while the VCSEL 202 is mounted on the top surface 223b of the intermediate layer 223 and the conductive patterns 224c are formed on the top surface of the first upper layer 224A. The bonding wires 206 connect these conductive patterns 224c to the VCSEL 202. Moreover, the top level of the VCSEL 202 is substantially equal to the top of the first upper ceramic layer 224A to shorten the length of the bonding wires 206.

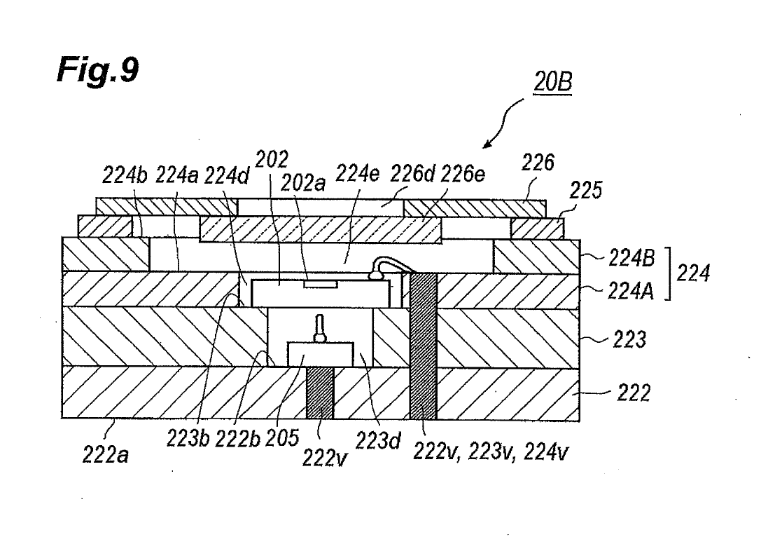

FIG. 9 shows a cross section of the optical device 20B. The monitor PD 205 is mounted in a center of the top surface 222b of the lower layer 222 where the top surface 222b is exposed in an opening 223d formed in the intermediate layer 223. The exposed surface 222b provides a conductive pattern on which the monitor PD 205 may be mounted. The conductive pattern is electrically connected through via holes 222v to an electrode formed in the bottom of the package 221. Formed in a center of the first upper layer 224A is an opening 224d where the devices are enclosed, and the top surface 223b of the intermediate layer 223 exposed in the space mounts the VCSEL 202. The opening 224d is larger than the other opening 223d formed in the intermediate layer 223; that is, a periphery of the upper opening 224d forms steps of the top surface 223b of the intermediate layer 223 to mount the VCSEL 202 thereon.

Provided above the opening 224d of the first upper layer 224A is another opening 224e for the bonding wire. The other opening 224e is wider than the opening 224d to expose the top surface 224a of the first upper layer 224A wide enough to form the conductive patterns thereof. These three openings, 223d, 224d, and 224e, are also hermetically sealed by the lid 226 and the seal ring 225 as those of aforementioned devices, 20 and 20A. However, the lid 226 of the present embodiment does not secure the lens. Instead, the lid 226 supports a window 226e made of plane material transparent for the light emitted from the VCSEL 202 that hermetically seals the openings, 223d, 224d, and 224e. The light from the VCSEL 202 transmits this window 226e and an aperture 226d formed in the ceiling of the lid 226.

The signal output from the monitor PD 205 is conducted to the wiring pattern formed in the top surface 222b of the lower layer 222 with bonding wires. The conductive pattern on the top surface 222b is connected with the electrode in the bottom of the package through via holes 222v in the lower layer 222. On the other hand, the driving signal for the VCSEL 202 is provided from the electrode in the bottom of the package 221 to the VCSEL 202 via the conductive pattern 224c in the top surface 224a of the first upper layer 224A through the via holes, 222v to 224v, continuously passing from the lower layer 222 to the first upper layer 224A.

The VCSEL ordinarily provides a high-reflectivity surface in the bottom thereof; accordingly, the laser light may be extracted only from the top surface of the device. When a VCSEL provides a back surface with a limited reflectivity as those of an edge-emitting type, an optical resonance becomes hard to be occurred. However, some types of VCSEL recently developed are able to emit laser light even when one of the reflection mirror provided in the bottom of the device has a limited reflectivity. The OSA 1B according to the present invention provides the optical coupling arrangement for such a new type of VCSELS.

The OSA 1B of the present embodiment may enhance the productivity because the multi-layered ceramic package 221 may continuously mount the monitor PD 205 on the lower layer 222 and the VCSEL 202 on the intermediate layer. Moreover, the OSA 1B may shorten a distance between the monitor PD 205 and the back facet of the VCSEL 202, which may be less than 1 mm short enough compared to the optical arrangement for the conventional edge-emitting LD; accordingly, the optical coupling efficient of the VCSEL 202 with the monitor PD 205 may be enhanced enough.

The embodiment shown in FIGS. 8 to 10 has the ceramic package 221 with the upper layer 224 thereof comprising the first and second layers, 224A and 224B. However, the OSA 1B of the present embodiment may provides the single upper layer 224 as those of the aforementioned embodiment, 1 and 1A. In such an arrangement of the upper layer 224, the VCSEL 202 is mounted on the top surface 223b of the intermediate layer 223 and this top surface 223b provides the conductive patters 223c to be connected with the top electrode of the VCSEL 202. When the VCSEL 202 is operated in relatively slower speed, the length of the wiring between the conducting patterns 223c and the electrode of the VCSEL 202 does not strongly affect the quality of the driving signal. Eliminating one of the upper ceramic layers, 224A or 224B, may permit the cost of the ceramic package 221 to be reduced.

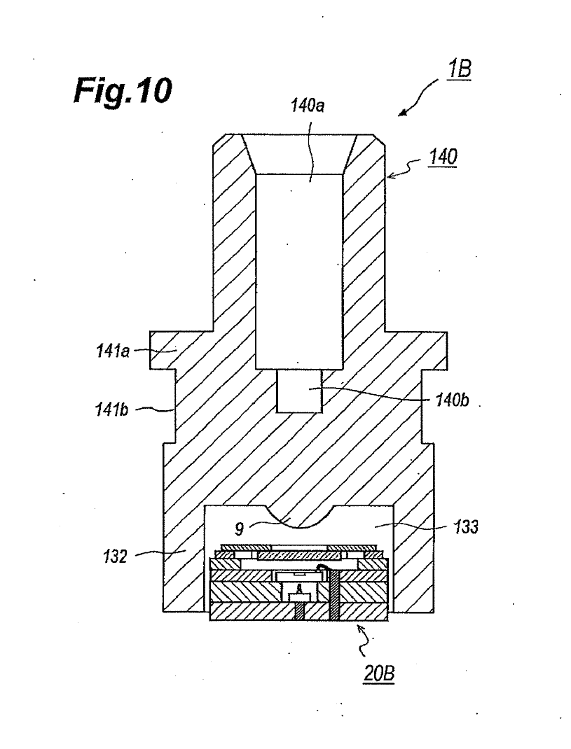

FIG. 10 is a cross section of the OSA 1B that implements the optical device 20B described above with a coupling portion 140. In the OSA 1B shown in FIG. 10, the joint portion 30 that is provided in the aforementioned OSAs 1 and 1A and the coupling portion are integrally molded with resin. The coupling portion 140 receives an external optical ferrule in a portion of the sleeve 140a. The position of the external ferrule may be determined by abutting a tip thereof against a step in the deep end of the sleeve 140a. The deep end of the sleeve 140a provides a hollow 140b which may set an optical member with a specific refractive index comparable to that of the optical fiber to make the physical contact against the fiber. The optical device 20B described above is set within a bore 133 of the cylinder 132 and fixed with adhesive therewith.

### Fourth Embodiment

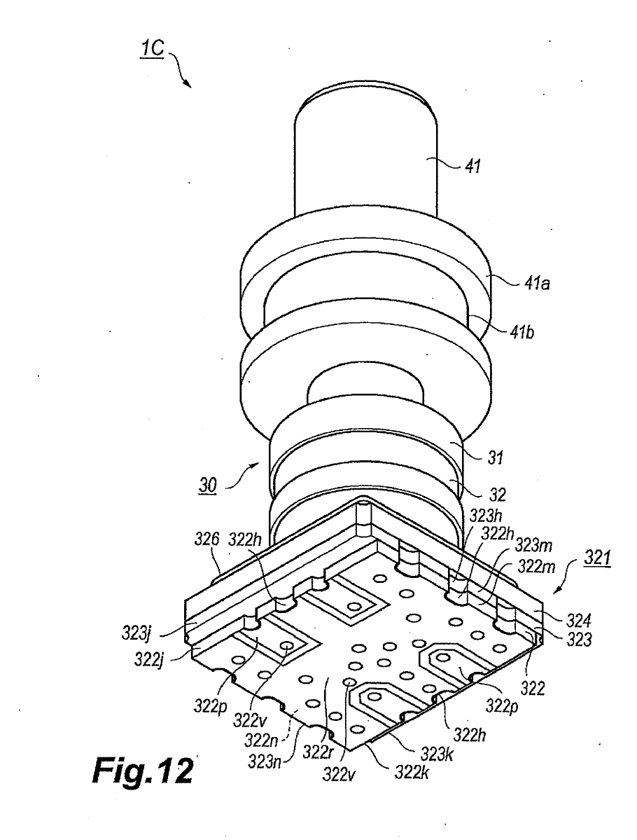

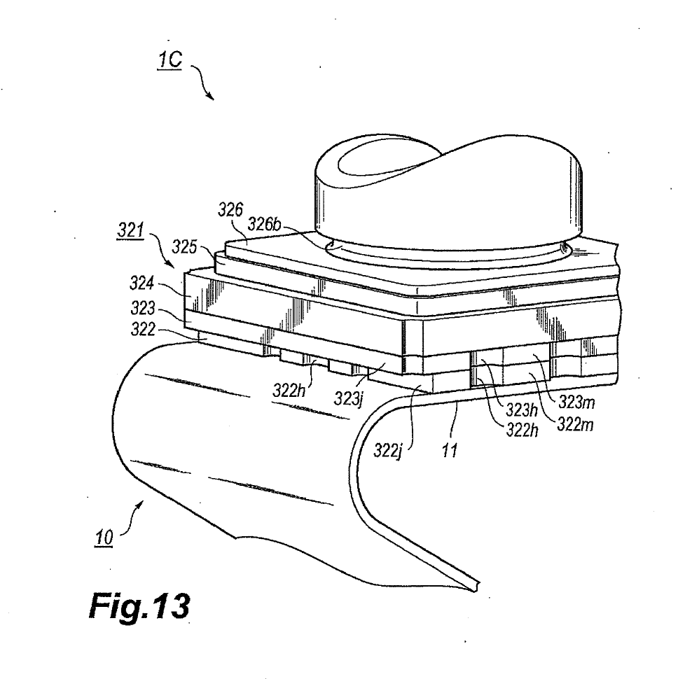

FIG. 12 is a bottom view of an OSA according to the fourth embodiment of the present invention, and FIG. 13 magnifies a primary portion of the OSA shown in FIG. 12.

The OSA 1C of the present embodiment provides a ceramic package 321 with a rectangular planar shape including four edges, 322j to 322n, of the lower ceramic layer 322. Respective edges provide a plurality of half-via holes 322h, three (3) via holes in an embodiment shown in the figures. The half-via holes 322h have a shape corresponding to a side surface of a pillar divided along the longitudinal axis thereof. The half-via holes 322h provide in the side surface thereof a coated thin conductive film to connect the ground pad 322r or the wiring pad 322p formed in the bottom surface of the lower layer 322 electrically to the conductive layer formed in the top surface of the lower layer 322. The half-via holes 322h are utilized to make a solder fillet when the FPC board 3 is soldered with the bottom surface of the lower layer 322, that is, an adequate amount of the solder may rise along the surface of the half-via holes 322h.

As illustrated in FIG. 12, the edge 322j of the lower layer 322 stays back from the edge 323j of the intermediate ceramic layer 323. In other words, the edge 323j of the intermediate layer 323 forms an overhang for the edge 322j of the lower layer 322. The edge 322k opposite to the aforementioned edge 322j also stays back from the edge 323k of the intermediate layer 323. Thus, the length between two edges, 322j and 322k, of the lower layer is shorter than the length between two edges, 323j and 323k, of the intermediate layer 323. Accordingly, the half-via holes 322h formed in the edges, 322j and 322k, of the lower layer 322 are discontinuous with the intermediate layer 323.

On the other hand, the edges, 322m and 322n, in the lower layer 322 which makes a right angle to the former edges, 322j and 322k, align with the edges, 323m and 323n, of the intermediate layer 323 without forming any overhangs. Thus, the length between the edges, 322m and 322k of the lower layer 322 is substantially equal to the corresponding length between the edges, 323m and 323n, of the intermediate layer 323; accordingly, the half-via holes 322h provided in those edges, 322m and 322n, of the lower layer 322 continues with the half-via holes 323h of the intermediate layer 323.

The edges, 323m and 323n, of the intermediate layer 323 provide a plurality of half-via holes 323h, where the embodiment shown in FIG. 12 provides three (3) via holes. The half via holes 323h in the intermediate layer 323 are coated with conductive thin film and formed in a portion aligned with a position of the half-via 322h in the lower layer 322 to connect the conductive patterns on the top surface of the intermediate layer electrically to the half-via holes 322h of the lower layer 322.

Referring to FIG. 13, the FPC board 10 is attached to the bottom of the lower ceramic layer 322 with, for instance the reflow soldering, so as to extend externally from the edge 322j thereof. Provided on the surface of the FPC 10 to be attached with the OSA 1C is a plurality of pads, which are not shown in FIG. 13. Thus, the FPC 10 is connected in the end portion 11 thereof with the conductive patterns, 322p and 322r, formed in the bottom of the OSA 1C. The FPC 10 may be bent in any portions thereof. The OSA 1C of the present embodiment bends the FPC 10 immediate to the edge 322j of the lower layer 332. The other end of the FPC 10 also provides a plurality of pad, not illustrated in FIG. 13, where they are soldered with pads on the circuit board arranged behind the OSA 1C.

FIG. 11 is a cross section of an arrangement where the OSA 1C of the present embodiment is set within the optical transceiver 100. The optical transceiver 100 provides the housing 50 whose front portion forms an optical receptacle 60 to guide an external optical connected to be optically coupled with the OSA 1C. The optical receptacle 60 fauns a projection 51 to hold the OSA 1C; that is, the flanges 41a of the OSA 1C put the projection 51 therebetween may align the OSA 1C with respect to the optical receptacle 60.

Rear of the OSA 1C installs the circuit board 70 that mounts electronic components 71 thereon. The OSA 1C is installed within the housing 50 such that the primary surface of the ceramic package 321 makes substantially a right angle to the primary surface 70a of the circuit board 70. The FPC board 10 is soldered with the pads 322p and the pattern 322r in the bottom of the lower layer 322 such that the end 11 thereof becomes in parallel with the primary surface of the lower layer 322, while, soldered with the circuit board 70 in the other end 12 thereof such that the end 12 becomes in parallel with the circuit board 70. Accordingly, the FPC 10 is necessary to be bent immediately close to the edge of the ceramic package 321 and also close to the edge of the circuit board 70 to form a U-shaped cross section.

The OSA 1C of the present embodiment provides half-via holes 322h in the edge 322j of the lower layer 322, which makes it possible to check visually the wettability of the solder by the fillet formed by an oozed excess solder. Further, the FPC 10 may be bent immediate close to the edge of the ceramic package 321 because the edge 322j of the lower layer 322 draws back from the edge 323j of the intermediate layer 323, which effectively prevents the excess solder from oozing out of the edge 323j of the intermediate layer 323. This arrangement makes it possible that, when the OSA 1C is installed within the housing 50, the FPC 10 in the bottom the U-shaped cross section is escaped from coming in contact with the inner wall of the housing 50.

In the embodiment described above, the lower ceramic layer 322 provides edges, 322j and 322k, both drawn back from the corresponding edges, 323j and 323k, of the intermediate layer 323. However, only the edge 322j from which the FPC 10 is outwardly extracted may be drawn back from the edge 323j of the intermediate layer 323. Further, the embodiment described above provides three half-via holes 322h in respective edges, 322j to 322n, in the lower layer 322, and also three half-via holes 323h in respective edges, 323m and 323n; however, the number of half-via holes 322h is not restricted to those arrangements. At least one half-via makes it possible to check visually the wettability of the solder to the conductive pattern on the FPC 10. Moreover, the FPC 10 may be bent at a position further close to the edge 323j of the intermediate layer 323 without any half-via holes in the corresponding edge 322j of the lower layer 322. In such an arrangement, the conductive patterns on the FPC 10 is necessary to be soldered with pads in the edge 322k opposite to the edge 322j, or other edges, 322m and 322n, making in perpendicular to the edge 322j, which inevitably lengthens the conductive pattern on the FPC 10. The embodiment shown in FIG. 12 prefers to shorten the length of the conductive pattern on the FPC 10 to secure the signal quality carried thereon.

### Fifth Embodiment

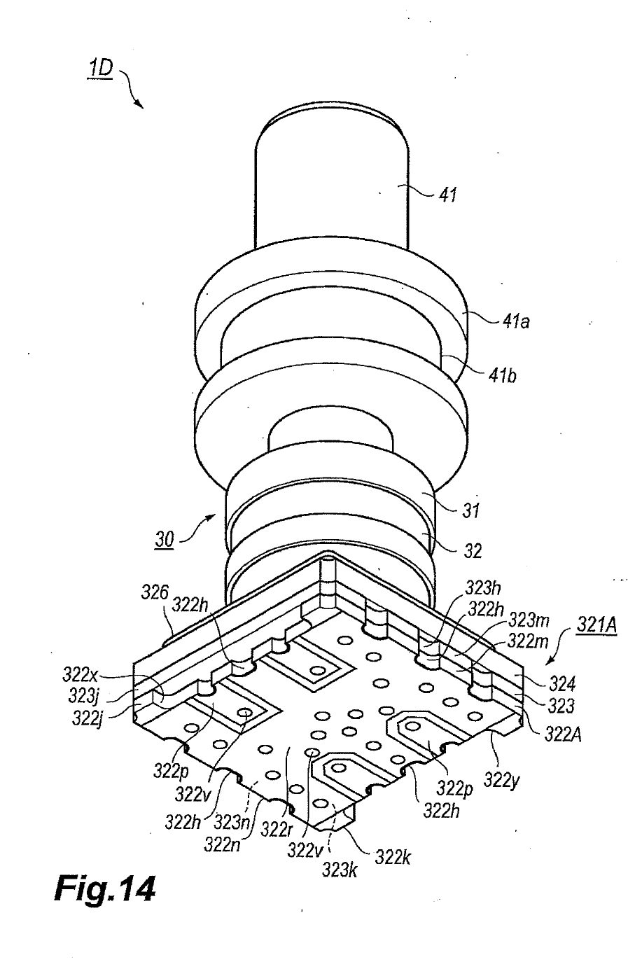

FIG. 14 is a bottom view of another OSA according to the fifth embodiment of the present invention. The OSA 1D of the present embodiment has a feature distinguishable from aforementioned OSA 1C that provides a ceramic package 321A. Other arrangements in the OSA 1D are same with or similar to those of the former OSA 1C. Further, the ceramic package 321A provides a lower ceramic layer 322A different from the lower layer 322 previously described; and other structures of the lower layer 322A are same with those of the ceramic layer 322.

The lower layer 322A provides two edges, 322j and 322k, opposite to each other. Other two edges, 322m and 322n, are aligned with the corresponding edges, 323m and 323n, of the intermediate layer 323. The two edges, 322j and 322k, each forms a cut, 322x and 322y, with a plurality of half-via holes 322h, and three (3) half-via holes are formed in the present OSA 1D, in a depth thereof. These half-via holes 322h are formed in the depth of the cuts, 322x and 323y, drawn back from the edge, 323j and 323k, of the intermediate layer. Accordingly, the FPC 10 outwardly extracted from the edge 322j may be bent immediate close to the edge 323j of the intermediate layer.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

1. An optical subassembly to be coupled with an external optical fiber, comprising:
an optical device providing a ceramic package including a plurality of ceramic layers, a metal lid, and a seal ring put between a top surface of said ceramic layers and said lid, said optical device installing a semiconductor optical device in a space hermetically sealed by said ceramic layers, said metal lid, and said seal ring;
a coupling portion that optically couples said external optical fiber with said semiconductor optical device; and
a joint portion that assembles said optical device with said coupling portion, said joint portion being welded to said metal lid.

2. The optical subassembly of claim 1, wherein said ceramic package includes at least a lower ceramic layer, an intermediate ceramic layer, and a upper ceramic layer,
wherein said semiconductor optical device is mounted on a top surface of said lower ceramic layer exposed in an opening formed in said intermediate ceramic layer, and
wherein said intermediate ceramic layer has electrically conductive patterns on a top surface thereof, said electrically conductive patterns being connected with electrically conductive patterns provided in a bottom surface of said lower ceramic layer with via holes.

3. The optical sub-assembly of claim 2, wherein said intermediate ceramic layer has a thickness substantially equal to a thickness of said semiconductor optical device, and
wherein said top surface of said irate mediate ceramic layer has a horizontal level substantially equal to a horizontal level of a top surface of said semiconductor optical device.

4. The optical sub-assembly of claim 2, wherein said seal ring is electrically isolated from said electrically conductive patterns provided on said top surface of said intermediate layer.

5. The optical sub-assembly of claim 2, wherein said optical coupling portion is electrically connected with said seal ring through said joint portion and said metal lid but electrically isolated from said electrically conductive patterns provided on said top surface of said intermediate ceramic layer.

6. The optical sub-assembly of claim 2, wherein said semiconductor optical device is a laser diode with an optical axis substantially in parallel to a primary surface of said ceramic package, and
wherein said optical device further provides an optical element and a monitor photodiode, said optical element reflecting a portion of light emitted from said laser diode toward a direction in substantially perpendicular to said primary surface of said ceramic package and refracting another portion of said light toward said monitor photodiode.

7. The optical sub-assembly of claim 6, wherein said laser diode, said optical element and said monitor photodiode are mounted on said top surface of said lower ceramic layer exposed in said space formed in said intermediate layer.

8. The optical sub-assembly of claim 7, further comprising a sub-mount with a top surface for mounting said laser diode thereon,
wherein said top surface of said sub-mount has a horizontal level substantially equal to said top surface of said intermediate ceramic layer.

9. The optical sub-assembly of claim 6, wherein said optical element is a prism with a light incident surface facing said laser diode and a light emitting surface facing said monitor photodiode, and
wherein said light incident surface makes an angle of substantially 45° with respect to said primary surface of said ceramic package.

10. The optical sub-assembly of claim 8, wherein said prism has another surface facing said sub-mount, said other surface has a chamfered corner in a lower side thereof.

11. The optical sub-assembly of claim 2, wherein said semiconductor optical device is a photodiode and said lid secures a lens in a center portion thereof, said photodiode receiving light provided from said external fiber and concentrated by said lens.

12. The optical sub-assembly of claim 2, wherein said semiconductor optical device is a VCSEL and said optical device further includes a monitor photodiode to monitor light emitted from a back facet of said VCSEL, and
wherein said monitor photodiode is mounted on said top surface of said lower ceramic layer, and said VCSEL is mounted on said top surface of said intermediate ceramic layer.

13. The optical sub-assembly of claim 12, wherein said upper ceramic layer includes a first upper layer on said intermediate layer and a second upper layer on said first upper layer, and
wherein said first upper layer provides an opening greater than said opening formed in said intermediate layer and being aligned with said opening of said intermediate layer, said VCSEL is mounted on said top surface of said intermediate layer exposed in said opening of said first upper layer.

14. The optical sub-assembly of claim 1, further comprising an FPC board electrically connected with said optical device,
wherein said FPC board is electrically connected with said conductive patterns provided on said top surface of said intermediate ceramic layer but electrically isolated from said optical coupling portion and said joint portion.

15. The optical subassembly of claim 14, wherein said optical device is installed in an optical transceiver with an electrically conductive housing and a circuit coupled with said optical device through said FPC board, and
wherein said joint portion and said optical coupling portion are electrically connected to said housing but said FPC board and said circuit are isolated from said electrically conductive housing.

16. The optical subassembly of claim 12, wherein said ceramic package has a substantially rectangular shape comprising a lower ceramic layer, an intermediate ceramic layer, and an upper ceramic layer, said lower ceramic layer providing a half via in at least one of edges of said rectangular shape.

17. The optical subassembly of claim 16, wherein said lower ceramic layer has a width shorter than a width of said intermediate layer to form an overhang to said intermediate layer, and
wherein said FPC board is attached to a bottom surface of said lower ceramic layer and extended outwardly from an edge where said intermediate layer forms said overhang.

18. The optical subassembly of claim 17, wherein said FPC board includes an electrically conductive pattern that carries a high speed electrical signal, and
wherein said electrically conductive pattern is connected with said half via provided in said one of edges of said lower ceramic layer.

19. The optical subassembly of claim 16, wherein said intermediate ceramic layer has an edge providing at least a half via, said edge being aligned with said at least one of edges of said lower ceramic layer, and
wherein said half via provided in said edge of said intermediate layer continues from said half via provided in said at least one of edges of said lower ceramic layer.

20. The optical subassembly of claim 19, wherein said FPC board includes an electrically conductive pattern that carries a low speed or DC electrical signal, and
wherein said electrically conductive pattern is connected with said half via provided in said one of edges of said lower ceramic layer and continued to said half via provided in said intermediate ceramic layer.

21. The optical subassembly of claim 1, wherein said seal ring has an aspect ratio smaller than 1.5 in said cross section thereof.

22. The optical subassembly of claim 1, wherein said ceramic package has a thickness of 2 mm at most.

23. The optical subassembly of claim 1, wherein said lid is made of Kovar.

24. The optical subassembly of claim 1, wherein said joint portion is made of stainless steel.
